(19) United States
(12) Patent Application Publication
(10) Pub. No.: US 2024/0429416 A1
(43) Pub. Date: Dec. 26, 2024

(54) INTRINSICALLY SAFE CATALYTIC RECOMBINER AND DOMESTIC POWER PLANT AND METHOD FOR OPERATING SAME

(71) Applicant: HPS Home Power Solutions GmbH, Berlin (DE)

(72) Inventor: Uwe BENZ, Uhldingen-Mühlhofen (DE)

(21) Appl. No.: 18/737,000

(22) Filed: Jun. 7, 2024

Related U.S. Application Data
(63) Continuation-in-part of application No. PCT/EP2022/085067, filed on Dec. 8, 2022.

(30) Foreign Application Priority Data
Dec. 8, 2021 (DE) 102021132320.7

(51) Int. Cl. H01M 8/0662; C25B 9/67; C25B 15/021; C25B 15/08; H01M 8/04014; H01M 8/04029; H01M 8/04089; H01M 8/04111; H01M 8/04223; H01M 8/0432; H01M 8/04746

(52) U.S. Cl. CPC H01M 8/0662; C25B 9/67; C25B 15/021; C25B 15/085; H01M 8/04014; H01M 8/04029; H01M 8/04097; H01M 8/04111; H01M 8/04231; H01M 8/04343; H01M 8/04776; H01M 2250/10

(57) ABSTRACT

A catalytic recombiner is provided for the catalytic, flameless recombination of a hydrogen-containing purge gas originating from a fuel cell unit and/or an electrolysis unit of a domestic energy center, having a reactor housing with a reactor chamber, an air inlet duct via which air can flow into the reactor housing, a purge inlet duct via which a hydrogen-containing purge gas can flow into the reactor housing, and an exhaust air outlet duct via which heated exhaust air can flow out of the reactor housing, the reactor chamber having two reaction stages, a pre-reaction stage a main reaction stage and a post-reaction stage and wherein a gas-permeable flame arrester is provided between the reactor chamber and the air inlet duct as well as between the reactor chamber and the exhaust air outlet duct.

### FIELD OF THE APPLICATION

The present application relates to a catalytic recombiner for catalytically recombining a hydrogen-containing purge gas originating from a fuel cell unit and/or an electrolysis unit with air. The application also relates to a method for operating a home energy center.

### BACKGROUND OF THE DISCLOSURE

Catalytic conversion of hydrogen-containing purge gases in a catalytic recombiner is generally known from the state of the art. Typically, fuel cell units are purged on the anode side and electrolysis units are purged on the cathode side in order to maintain the performance of the fuel cell unit and/or the electrolysis unit in the long term or to reduce the pressure in the hydrogen spaces of the fuel cell unit or the electrolysis unit. The purge gas containing hydrogen is usually diluted with air and released into the environment. During purging of fuel cells and electrolysis units, a hydrogen-rich purge gas is released in pulses over a short period of time, for example for a duration of 0.2 to 0.5 seconds, with a quantity of typically approx. 0.3 to 1 NI (Normliter: standard liter) per kW nominal power of fuel cell or electrolysis. Diluting the resulting volume flows of hydrogen-rich gas of typically approx. 2 to 20 m³/h per kW nominal power of fuel cell or electrolysis safely, i.e. generating an H₂ concentration of always well below 4% in terms of time and location, places very high demands on the diluting air volume flow and the device for efficient and safe mixing of the gases. In the above example, this would require very high dilution air flows of approx. 100 to 2000 Nm³/h (Norm cubic meters per hour). The energy contained in the hydrogen-containing purge gas is lost in the process.

It is the object of the present application to provide an improved catalytic recombiner and a use of a catalytic recombiner.

### SUMMARY OF THE DISCLOSURE

With regard to the catalytic recombiner, the problem is solved by a catalytic recombiner for the catalytic, flameless recombination of a hydrogen-containing purge gas originating from a fuel cell unit and/or an electrolysis unit of a domestic energy center. The catalytic recombiner comprises a reactor housing with
a reactor chamber,
an air inlet duct through which air can flow into the reactor housing,
a purge inlet duct through which a purge gas containing hydrogen can flow into the reactor housing, and
an exhaust air outlet duct through which heated exhaust air can flow out of the reactor housing.

The reactor chamber preferably has a pre-reaction stage, a main reaction stage and a post-reaction stage, and a gas-permeable flame arrester is preferably provided between the reactor chamber and the air inlet duct and between the reactor chamber and the exhaust air outlet duct.

The pre-reaction stage, the main reaction stage and the post-reaction stage in the reactor chamber are preferably realized by a pre-reaction zone, a main reaction zone and a post-reaction zone inside the reactor chamber and can, for example, be spatially defined by separating elements or result during operation from appropriately set process parameters such as the volume flows of air and hydrogen in combination with the spatial design of the reactor chamber as well as the arrangement and design of the air inlet duct and the purge inlet duct.

In the first zone for the pre-reaction stage, preferably an increased edge mobility for the air flowing through the reactor chamber is provided. Accordingly, the reactor chamber in the pre-reaction stage is preferably designed in such a way that, during operation, the air flowing through the reactor chamber assumes an increased edge mobility.

Preferably, the reactor chamber in the main reaction stage has a thermal smoothing stage to reduce temporary and local temperature peaks of the catalyzed purge gas. The thermal smoothing stage can be achieved by distributing the thermal masses. For this purpose, a mass of 50 g to 300 g of steel or copper or aluminum can preferably be introduced into the main reaction zone as a thermal mass per kW of nominal fuel cell or electrolysis power.

This-approximately 200 g of sheet steel-corresponds, for example, to a circular disk-shaped perforated metal plate with a diameter of 100 mm and a thickness of 5 mm, in which 50% of the surface is perforated, said plate being installed perpendicular to the direction of flow in a reactor with an internal diameter of 100 mm. Accordingly, the thermal mass can be provided in the form of such a perforated metal plate. Several thinner perforated metal plates arranged so that the gas can flow through them one after the other also fulfill the purpose and at the same time serve to improve the mixing of the gas. If the inner diameter of the reactor is smaller, e.g. 70 mm, the number of plates would simply double-reciprocally to the reduction in surface area.

Spheres made of iron, copper or aluminum with a diameter of about 2 mm to 6 mm and with the same total mass, mixed with the catalytically active material (e.g. the catalyst pellets), also have a similarly comparative effect on the temporally (and somewhat less on the locally) variable temperature of the purge gas to be recombined.

The reactor chamber is preferably adiabatic in the post-reaction stage in order to minimize heat losses there and to ensure a safe start of the recombination reaction even at low hydrogen concentrations in the purge gas.

The last zone for the post-reaction stage is designed for a safe start of the reaction and reliable residual conversion. It can be heated for this purpose.

The application includes the realization that a hydrogen-containing purge gas can be used to generate energy in a home energy center, since a catalytic conversion of a hydrogen-containing purge gas generates heat at a very usable temperature level, and a catalytic conversion of the hydrogen-containing purge gas that would otherwise have to be discharged elsewhere is environmentally friendly.

By means of the catalytic recombiner according to the application, a converted hydrogen-containing purge gas can be used to preheat process water of the building energy center and/or to directly or indirectly preheat room supply air of a room ventilation system.

The gas-permeable flame arresters are preferably designed as a sintered disk or as a metal fleece and preferably have pores with an effective pore diameter of between 0.02 mm and 0.5 mm.

Preferably, the catalytic recombiner has a heat exchanger or is connected to one. The heat exchanger can be an exhaust gas/water heat exchanger, an exhaust gas/air heat exchanger or a water/water heat exchanger. Preferably, an exhaust gas/water heat exchanger is provided for preheating the process water of the home energy center. Preferably, an exhaust gas-air heat exchanger is provided for preheating room supply air of a room ventilation system. Exhaust gas can be understood as a catalytically converted purge gas, which can also be diluted and cooled by adding air.

The heat exchanger can be realized in that the reactor housing has an inner housing wall that delimits the reactor chamber and an outer housing wall that is spaced from the inner housing wall by an intermediate space. In this case, the exhaust air outlet duct can at least in sections be formed by the intermediate space. Alternatively or additionally, the outer housing wall can have a coolant inlet and a coolant outlet and the intermediate space can be designed as a cooling duct through which a liquid coolant can flow.

In one embodiment of the catalytic recombiner, the pre-reaction stage and the main reaction stage as well as the main reaction stage and the post-reaction stage are each separated from one another by a perforated metal plate. The main reaction stage can be divided into at least two main stage areas by at least one main stage perforated metal plate. Preferably, the perforated metal plates are connected to the inner housing wall with good thermal conductivity for the purpose of heat dissipation. It is also preferred if the at least one main stage perforated metal plate has a catalyst coating.

In a preferred embodiment, the catalytic recombiner has an activation terminal and/or a heating element for supplying electrical and/or thermal process energy. The catalytic recombiner can be supplied with electrical and/or thermal process energy via the activation terminal to activate a catalytic reaction. Preferably, the catalytic recombiner is supplied with electrical and/or thermal process energy from the domestic energy system. Electrical energy can, for example, be provided by a fuel cell unit and/or an electrical storage unit of a home energy center. Thermal process energy can, for example, be provided by a boiler, such as a pellet boiler, connected to the home energy system control center.

An exhaust gas/water heat exchanger, which is suitable for preheating process water in the domestic energy system, can also be used to introduce thermal process energy, for example via the flow or return of a boiler. At the same time, the discharge of energy via an exhaust gas/water heat exchanger and/or an exhaust gas/air heat exchanger has the advantage that temperature peaks during the catalytic combustion of the hydrogen-containing purge gas, which can cause catalyst damage, are reduced. This means that even increased fuel concentrations, which can occur locally in the catalytic recombiner, can be permanently and robustly reduced.

In an advantageous embodiment, the catalytic recombiner has a mixing section for mixing hydrogen with air. In this way, a combustion ratio can be optimally adjusted. The mixing section can have a connection to a house ventilation system, via which air can be introduced into the mixing section of the catalytic recombiner.

To form a mixing section, the pre-reaction stage can be free of a catalyst during operation and be designed as a mixing stage for mixing hydrogen with air. Flow guide elements and/or inert pellets can be provided in the pre-reaction stage.

In a preferred embodiment, the catalytic recombiner is designed as a concentric pipe system. The length of the reactor chamber is preferably greater than its diameter.

Preferably, the catalytic recombiner has a thermal smoothing stage to reduce temporary temperature peaks of the catalyzed purge gas. Short-term concentration peaks can be evened out and attenuated by a targeted distribution of the thermal masses at the critical points, particularly in the main reaction zone. The thermal masses are preferably well coupled to the catalytically converted purge gas via standard design and flow engineering measures.

Preferably, the catalytic recombiner has an adiabatic post-reaction stage with an oxidation catalyst.

Preferably, a catalytically active layer of the catalytic recombiner has a diffusion barrier layer at least in one reaction chamber section, in particular preferably in the main reaction stage, which preferably consists of or comprises aluminum oxide or an inert, temperature-resistant, microporous material. The diffusion barrier layer covers a catalyst-containing layer—for example a platinum-containing layer—so that only a limited amount of purge gas can penetrate through the pores of the diffusion barrier layer to the catalyst. In this way, the reaction can be slowed down in a self-locking manner via diffusion of the reactants, in particular hydrogen and oxygen, and counter-diffusion of the products, in particular water vapor, and favorable temperature smoothing, which is desirable in the area of potentially higher fuel concentrations, can be achieved. The catalytic recombiner can have flow guide elements in at least one section of the reaction chamber for mixing or to support the desired edge flow and/or inert pellets.

In a particularly preferred embodiment, the catalytic recombiner is designed as a concentric tube. Preferably, the catalytic recombiner is designed as a concentric pipe system with a cooling duct through which a liquid coolant can flow. The cooling duct can be part of a heat exchanger or connected downstream of such a heat exchanger.

Particularly preferably—and regardless of the specific geometric design—the catalytic recombiner is designed for nominal operation with 0 to 10% hydrogen in air so that the reaction temperatures occurring remain below the critical limits for the catalysts and structural materials of the recombiner. The materials of the structure of the recombiner are preferably austenitic stainless steels.

According to a further aspect of the application, a home energy center with at least one fuel cell unit and one electrolysis unit is provided, wherein the home energy center comprises a catalytic recombiner, in particular a catalytic recombiner as described above, for catalyzing a hydrogen-containing purge gas originating from the fuel cell unit and/or the electrolysis unit.

Other advantageous aspects of the catalytic recombiner are as follows:

To ensure that the reaction in the reactor chamber starts reliably, heating and/or a locally targeted increased concentration of H₂ can optionally be provided. For this purpose, the catalytic recombiner can have suitable electrical heating (e.g. cartridge heaters), preferably in the post-reaction stage or in the main reaction stage, in order to warm up the catalytic recombiner before the air flow and purge gas are supplied; the thermal inertia then ensures that the catalyst remains sufficiently warm even after initiating the air supply in order to have a high catalytic activity for conversion of the hydrogen immediately upon addition of the hydrogen.

Optionally, heat can be transferred from the product gas to the reactant gas inside or outside the catalytic recombiner in order to preheat the reactant gas and thereby accelerate recombination in the subsequent stages.

Optionally, H₂ can be added to the air flow within the reaction zone. This allows heat sources to be generated locally by H₂ recombination at higher temperatures (hot spots), which also accelerate the overall reaction.

To ensure that the reaction in the reactor chamber is robust and safe, repeated or continuous local dosing of the H₂ can take place within the catalytic recombiner. Multiple dosing points and/or dosing or mixing via micro-structures or a porous body can be provided for this purpose.

In order to equalize the concentrations, it may be necessary to attenuate an H₂ pulse via upstream accumulators (e.g. bellows, pressure accumulator). It is also possible for the mixture to be formed via a mixture within a safe, catalyst-free area upstream of the reaction zone.

In order to further equalize the concentration, it may also be necessary to add the air volume flow as synchronously as possible with the hydrogen volume flow added in pulses. This can be realized, for example, by arranging a compressor in conjunction with a small pressurized air reservoir and a solenoid valve. The compressor is preferably designed according to the positive displacement principle, for example as a diaphragm pump, a dry-running piston pump or a vane pump. The pressurized air reservoir preferably has a volume of approx. 0.5 to 5 liters and a maximum pressure of approx. 0.3 to 3 bar.

Narrow structures (with an effective pore diameter that is smaller than the extinguishing distance of approx. 0.7 mm), for example sintered metal inserts or metal fleeces in front of and behind the reactor chamber and/or high flow velocities can be provided to prevent any flame propagation. Structures with such small cross-sections can also be provided in the reactor chamber, e.g. between the catalyst pellets.

The catalytic recombiner can also be designed so that the flow velocity in the reactor chamber is greater than the flame velocity, in particular greater than 3.5 m/sec.

It may also be necessary to inhibit the reaction in areas of potentially high concentration. A diffusion barrier (e.g. a porous layer or a metal fleece or a sintered structure made of metal or ceramic) between the gas mixture and the catalyst can be used for this purpose. The diffusion barrier is preferably a diffusion barrier layer on a respective catalyst pellet. The respective catalyst, in particular noble metal catalysts of the platinum metal group such as Pt (platinum) and Pd (palladium), is preferably applied to porous catalyst pellets, for example Al₂O₃ pellets. Such catalyst pellets can be coated with a diffusion barrier layer, for example, of porous Al₂O₃ (without catalyst), which limits the amount of catalyzed purge gas. Alternatively or additionally, an edge mobility can also be specifically increased by a corresponding shape of the reactor chamber and/or by inert mass, e.g. uncoated pellets of Al₂O₃ or inert metal beads. In this way, high concentrations of H₂ can be carried downstream into the reactor. An inert mass also acts as a thermally inert mass and attenuates local temperature peaks. A lower noble metal concentration at the entrance to the reactor chamber, possibly combined with increased edge mobility at the entrance to the reactor, can also help to inhibit the reaction in areas of potentially high concentration.

Preferably, a measurement of the temperature at the reactor outlet or in the post-reaction stage and/or in the main reaction stage is also provided. This helps to detect whether and when the reaction in the reactor chamber starts. In this case, an emergency purge mode can be activated as a result of the detection of a non-start, in which the concentrations in the mixing zones of the recombiner exhaust gas and the main exhaust air flow of the house energy system, downstream of the recombiner of H₂ are kept below approx. 2% to 4%. Measuring the temperature at the reactor outlet also makes it possible to detect a malfunction in the system if the temperature is too high and to take appropriate countermeasures. For example, if the reaction does not start or if the outlet temperature of the catalytically converted purge gas is too high, the addition of air upstream of or into the recombiner can optionally be switched off. Furthermore, temperature measurement at one or more points enables robust thermal management of the reactor.

A specifically provided thermally inert mass or inert mass of the reactor (wall of the reactor chamber and/or inert material in the reactor chamber and/or the pellet filling), for example in the form of inert metal beads, dampens temperature peaks and enables safe intervention in the event of a fault by measuring the temperature at the reactor outlet or on the outer surface of the wall of the reactor chamber.

The catalytic recombiner can be advantageously cooled from the outside, for example by the main exhaust air flow. The outer surface can also be enlarged by finning. Liquid cooling can also be provided on the outer casing of the catalytic recombiner.

The higher the temperature of the reactor chamber, the more heat is dissipated. This results in a self-regulating effect against excessively high reactor temperatures, so that the external temperature of the reactor housing can be kept below 300° C. This means that inexpensive materials can be used for the reactor housing.

For efficient cooling of the reaction zones, an efficient removal of heat, narrow gaps for the gas flow or the reactor chamber, optional heat conducting structures in the gas flow within the reactor chamber and/or a coating of the catalyst on a heat-absorbing wall in the reactor chamber are preferably provided.

The following variants are preferred with regard to the reactor chamber:

The reactor chamber can be filled with catalyst pellets. Alternatively or additionally, a monolithic catalyst is provided.

Catalyst-coated mixer elements (static mixers) can be provided in the reactor chamber. Coated reactor structures with or without a diffusion layer may be provided, which may be thermally coupled directly to the reactor housing.

If necessary, different catalyst carriers can be provided in the reactor chamber along the direction of flow. For example, upstream coated structures close to the wall can be provided. These enable very good heat dissipation. Catalyst-coated pellets (catalyst pellets) then follow in the direction of flow, which enable moderate heat removal. Finally, a monolithic catalyst can follow downstream, which offers largely adiabatic reaction control. The latter aspect particularly promotes a fast start of the reaction and a good residual conversion.

A further aspect is a home energy center with at least one fuel cell unit and/or one electrolysis unit and with a catalytic recombiner of the type presented herein, which is integrated into the home energy center for recombining a hydrogen-containing purge gas originating from the fuel cell unit and/or the electrolysis unit using the exhaust air flow.

Preferably, the catalytic recombiner is integrated into the home energy center in such a way that it can be supplied with electrical and/or thermal process energy from the home energy center to activate a catalytic reaction.

Preferably, the catalytic recombiner is integrated into the building energy center in such a way that heated exhaust air (AL) exiting via the exhaust air outlet duct can be used to heat an occupied room.

Preferably, a device for equalizing the purge gas flow, e.g. a purge chamber, in particular a dynamic purge chamber, is connected upstream of the catalytic recombiner.

A further aspect relates to a method for operating a home energy center, comprising the following steps:
conducting a hydrogen-containing purge gas (H₂) originating from a fuel cell unit and/or electrolysis unit into the purge inlet duct of the catalytic recombiner, preferably with a pulsating volume flow of 2 to 20 m³/h per kW nominal power of fuel cell or electrolysis. In a preferred arrangement, this pulse-like volume flow is smoothed over time via an equalizing reservoir and thus preferably reduced by a factor of 5 to 20;
conducting an exhaust air volume flow of the building energy center, preferably with a volume flow which is greater by a factor of at least 10 than the volume flow of the hydrogen-containing purge gas in the air inlet duct; and
conducting heated exhaust air (AL), which comes from the exhaust air outlet duct of the catalytic recombiner and which is preferably mixed with other exhaust air from the home energy center, into a gas-gas heat exchanger of the home energy center.

Preferably, the exhaust air volume flow from the home energy center is fed into the air inlet duct by means of a compressor. The compressor is preferably activated before purging the fuel cell unit and/or electrolysis unit. Preferably, the compressor is deactivated 5 to 30 seconds after purging of the fuel cell unit and/or electrolysis unit.

In a further preferred design, both the hydrogen volume flow and the air volume flow are pulsed via buffer reservoirs and solenoid valves in such a way that the mixing concentrations remain within narrow limits despite time-varying reactant volume flows. By appropriately dimensioning the components, both the mixing concentrations and the upstream and downstream air flow can be adjusted and actively influenced during operation. The pulsing of the volume flow of the hydrogen-containing purge gas—and thus the hydrogen volume flow—and the pulsing of the air volume flow are preferably synchronized, i.e. pulses of hydrogen-containing purge gas and air pulses preferably occur synchronously.

Preferably, a catalytic reaction of the catalytic recombiner is activated on demand by means of electrical and/or thermal process energy from the home energy center.

Preferably, the method further comprises the following steps:
Check whether the temperature increase of the recombiner's exhaust air rises by a defined amount, preferably more than approx. 50K, during the purging process.
Heating the reactor chamber to a temperature greater than 50° C., preferably greater than 100° C., if the temperature increase of the recombiner exhaust air rises by less than approx. 50K during the purging process.

A method for operating as a recombinator for Purge may have the following steps:
Start
   Switch on the compressor and, if available, load the buffer reservoir
   At the first start after a longer break, preferably after longer than 12 hours, heating of the reactor chamber to a temperature greater than 50° C., preferably greater than 100° C.
   Start of the purge process of the fuel cell or the electrolyzer
Check whether the temperature increase of the recombiner exhaust air rises by a defined amount, preferably more than approx. 50K, during the purging process.
Heating the reactor chamber to a temperature greater than approx. 100° C. if the temperature increase of the recombiner exhaust air rises by less than approx. 50K during the purging process
Operation
   Switching off the heater
   Performing the regular purge processes during operation of the fuel cell or electrolyzer
   If necessary, readjust the air flow or, if available, open and close the solenoid valve synchronized with the H₂ purge process
   After-running of the compressor if an exhaust gas temperature higher than an upper limit value, for example 350° C., is reached during purge operation until the exhaust gas temperature has reached a lower limit value, for example 150° C.
Switch off
   After the last purge, the compressor after runs until the exhaust gas temperature has reached a lower limit value, for example 100° C.

For a process for simultaneous operation of the catalytic recombiner as a catalytic burner and as a catalytic recombiner, the air flow can be increased during the purge pulse if necessary.

According to a further aspect, a combination of a catalytic recombiner and an air accumulator is provided, which is connected to an air inlet duct of the catalytic recombiner. Preferably, a compressor is also provided to create an overpressure in the air reservoir. In addition, a valve is preferably provided to allow air from the air reservoir to flow into the reactor chamber of the catalytic recombiner via the air inlet duct of the catalytic recombiner at a given time by opening the valve. Furthermore, a control system is preferably provided in order to synchronize the purging—i.e. the introduction of hydrogen-containing gas through the purge inlet duct into the reactor chamber—with the opening of the valve in such a way that hydrogen-containing gas from the fuel cell stack and air from the air reservoir flow into the reactor chamber of the catalytic recombiner simultaneously. The synchronization can take place in such a way that, for example, a purge process is triggered first and the opening of the valve between the air reservoir and the catalytic recombiner only takes place with a delay, the duration of said delay corresponding to the time it takes for the hydrogen-containing gas to flow into the reactor chamber of the catalytic recombiner after the purge process has been triggered.

The combination of a catalytic recombiner with an air reservoir, which allows synchronized air pulses to be supplied to the reactor chamber of the catalytic recombiner with a purging process, represents an independent inventive idea, which can also be combined with all variants of such a catalytic recombiner independently of the other details of the catalytic recombiner.

### BRIEF DESCRIPTION OF THE FIGURES

Exemplary embodiments of the present application are explained below with reference to the attached figure. It shows:

FIGS. 1a and 1b: schematic representation of variants of a first embodiment of a catalytic recombiner according to the application;

FIGS. 2a and 2b: schematic representation of variants of a second embodiment of a catalytic recombiner according to the application;

FIG. 3: a schematic representation of a third embodiment of a catalytic recombiner according to the application;

FIG. 4: a schematic representation of a first example of a domestic energy system; and

FIG. 5: A schematic representation of a combination of a catalytic recombiner and an air accumulator for the pulse-like supply of an air flow into the reactor chamber of the catalytic recombiner.

### DETAILED DESCRIPTION OF THE FIGURES

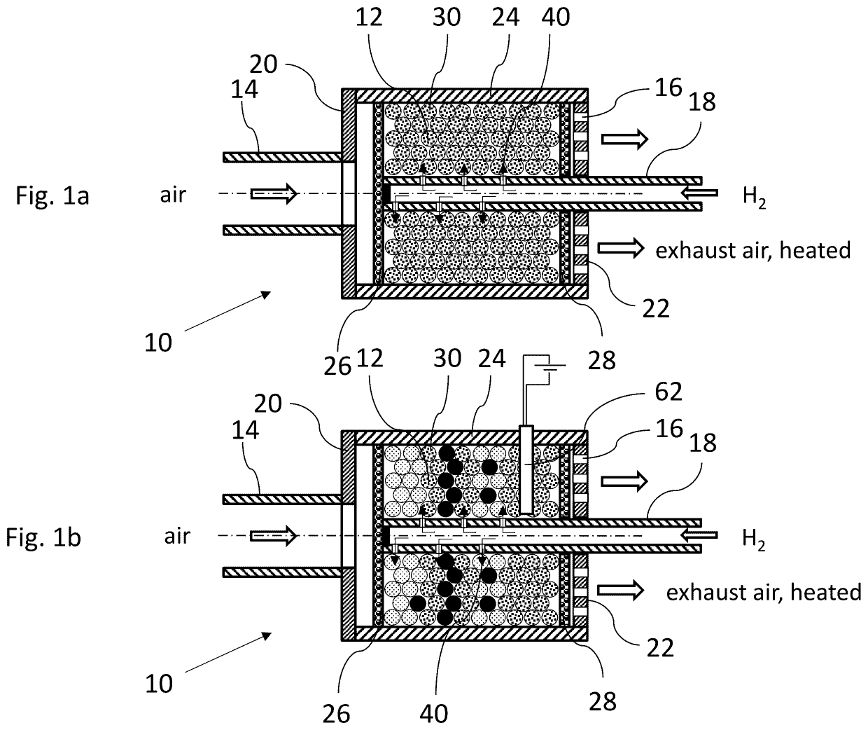

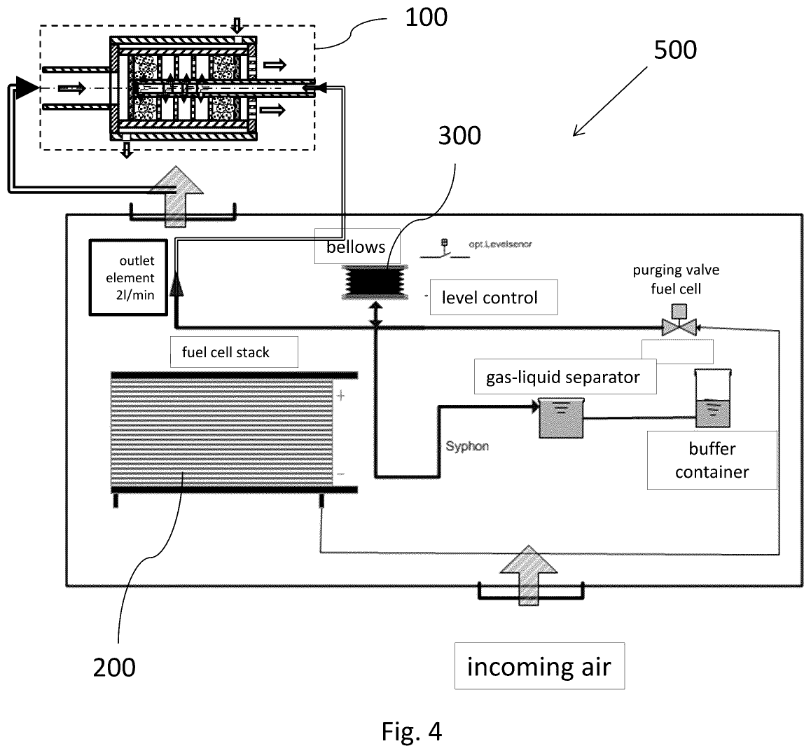

A catalytic recombiner 100 (see FIGS. 1 to 3), such as can be used in combination with a fuel cell unit 200 and/or an electrolysis unit of a home energy center 500 (see FIG. 4), has a reactor housing 10 which encloses a reactor chamber 12 and has an air inlet duct 14 as well as an exhaust air outlet duct 16 and a purge inlet duct 18. The air inlet duct 14 and the exhaust air outlet duct 16 are arranged such that air can be fed into the reactor chamber 12 via the air inlet duct 14, can flow through the reactor chamber 12 and can exit the reactor chamber 12 again via the exhaust air outlet duct 16. The air inlet duct 14 and the exhaust air outlet duct 16 can have different shapes; in particular, several air inlet ducts 14 and several air outlet ducts 16 can also lead to a reactor chamber 12 and lead away from the reactor chamber 12. In the reactor chamber 12, air flowing in through the air inlet duct 14 and hydrogen-containing gas flowing in through the purge inlet duct 18 are brought together so that the hydrogen H₂ in the hydrogen-containing gas can react with the air. The gas mixture produced as a result of the reaction can then exit the reactor housing 10 again via the exhaust air outlet duct 16 or the exhaust air outlet ducts 16. The purge inlet duct 18 preferably protrudes into the reactor chamber 12 in the manner of a lance.

The reactor housing 10 has a front end wall 20 and a rear end wall 22 as well as a peripheral wall 24.

The reactor chamber 12 of the catalytic recombiner 100 preferably has a round, in particular circular, cross-section and a length that is greater than the diameter.

The catalytic recombiner 100 is designed so that it can be operated safely under various operating conditions. The hydrogen-containing gas mixture supplied via the purge inlet duct 18 is typically a gas mixture that is produced during the purging of a fuel cell unit and/or an electrolysis unit. The hydrogen content of the gas mixture finally discharged to the environment as exhaust air should be as low as possible. This can be achieved by diluting the gas mixture produced during purging.

However, the hydrogen in the gas mixture produced during purging can also be reduced with the aid of a catalytic recombiner of the type described herein in that the hydrogen in the recombiner 100 reacts with the oxygen from the supplied air to form water, which can then be discharged from the catalytic recombiner 100, for example in the form of vapor with the exhaust air. Since the hydrogen content of the gas mixture produced during purging can vary, safe operation of the catalytic recombiner 100 should be possible both with low hydrogen contents of, for example, 0.5 to 2% by volume of H₂ in the purge gas and with higher hydrogen contents of, for example, 2 to 10% by volume.

For this purpose, the catalytic recombiner 100 has a gas-permeable flame arrester 26 or 28 both between the air inlet duct 14 and the reactor chamber 12 and between the reactor chamber 12 and the exhaust air outlet duct 16, which prevents potential flames resulting from the reaction of the oxygen with the hydrogen in the reactor chamber from striking out of the reactor chamber 12 into the air inlet duct 14 or exhaust air outlet duct 16.

The background to this is that H₂-based fuel cells and/or electrolysers must be purged on the fuel side during operation in certain situations (purging).

During operation or in standby mode, the hydrogen (H₂), which is under excess pressure in the fuel cell unit or the electrolysis unit, is expanded intermittently via a solenoid valve to flush impurities and liquid water out of the cells. This process results in a very high, pulse-like H₂-rich gas flow, which is usually diluted to below the lower ignition limit (4% H₂ in air) at any time via a relatively large air flow.

The problems here are that a high air flow is required, which must be designed for the temporarily highest H₂ mass flow, that the exhaust air still contains H₂, that the concentrations of H₂ in the exhaust air fluctuate greatly and that the concentrations at the admixing points are temporarily locally higher than the ignition limit. The latter is critical in terms of safety and requires additional safety measures.

Ideally, the H₂ should be recombined with the smallest possible air flow and, if necessary, the resulting heat energy should be utilized; however, there are other problems to consider here:
The presence of catalytic converters is generally to be regarded as a safety-related ignition source and may be safety-critical,
Recombination/catalytic combustion can generate very high temperatures, depending on the local and temporal concentration,
per percent H₂ in the mixture, an adiabatic temperature increase of approx. 85 K occurs; from 560° C., i.e. from approx. 6-7% H₂ in the air, ignition of the mixture on a hot surface is to be expected, and
At room temperature and H₂ concentrations below approx. 1%, the reaction starts, but often does not have a complete conversion due to the slower kinetics (at these temperatures, with short contact times)

The catalytic recombiner 100 presented herein enables good H₂ conversion even at low concentrations (e.g. 0.5 to 1.5% H₂) and temperatures of purge gas and especially air (e.g. room temperature) as well as safe operation without ignition at (temporarily) high concentrations (e.g. up to 10% H₂ in air) and/or temperatures. The catalytic recombiner 100 presented herein fulfills high safety requirements and is robust against concentration peaks by preventing ignitions and flashbacks as well as high housing temperatures and is safe even during ignitions. The catalytic recombiner 100 presented herein helps to prevent the formation of local concentration peaks in the open exhaust air flow, which always occur when H₂-rich gases are mixed with an exhaust air flow.

For this purpose, the reactor chamber 12 contains a catalyst, in particular noble metal catalysts of the platinum metal group such as Pt (platinum) and Pd (palladium), preferably on porous catalyst pellets 30, for example Al₂O₃ pellets. The catalyst pellets 30 may be coated with a diffusion barrier layer of porous Al₂O₃ (without catalyst), which limits the amount of catalyzed purge gas. Alternatively or additionally, a monolithic catalyst or catalyst-coated mixer elements (static mixers) can be provided.

The reactor chamber 12 and the air inlet duct 14 as well as the exhaust air outlet duct 16 are arranged in such a way that three zones are formed in the catalytic recombiner 100 during operation, namely a pre-reaction zone 32, a main reaction zone 34 and a post-reaction zone 36, so that the recombination of the hydrogen with the oxygen of the supplied air takes place in three stages, a pre-reaction stage, a main reaction stage and a post-reaction stage, in relation to the direction of flow of the air from the air inlet duct 14 to the exhaust air outlet duct 16.

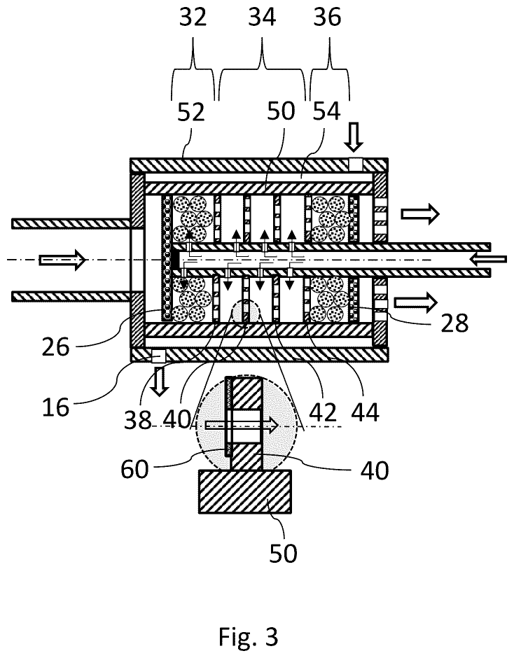

In different variants of the catalytic recombiner, this can be achieved by dividing the reactor chamber 12 by means of separating elements, preferably in the form of perforated metal plates 38, 40, 42 and 44 (see FIG. 3) and/or by correspondingly arranged and shaped dosing outlet openings 46 on the purge inlet duct 18. For this purpose, the purge inlet duct 18 is preferably designed as a tube projecting centrally into the reactor chamber 12, which is closed at its end and which has lateral dosing outlet openings 46 over the length over which the purge inlet duct 18 projects into the reactor chamber 12.

Different pellets 30 can also be provided, namely inert pellets in addition to catalyst pellets (shown lighter in FIG. 1b, i.e. with a less dense texture). For the pre-reaction stage 32, inert pellets can be provided in particular, which do not cause a reaction but a mixture of the gases. For the main reaction stage, catalyst pellets in particular are then provided; see FIG. 1b.

Preferably, in all the embodiments presented, air flows through the reactor chamber in the longitudinal direction (air inlet duct 14 and exhaust air outlet duct 16 are arranged and designed accordingly), while the hydrogen-containing gas mixture is introduced centrally into the reactor chamber 12, distributed over the length of the reactor chamber 12, by means of the purge inlet duct 18.

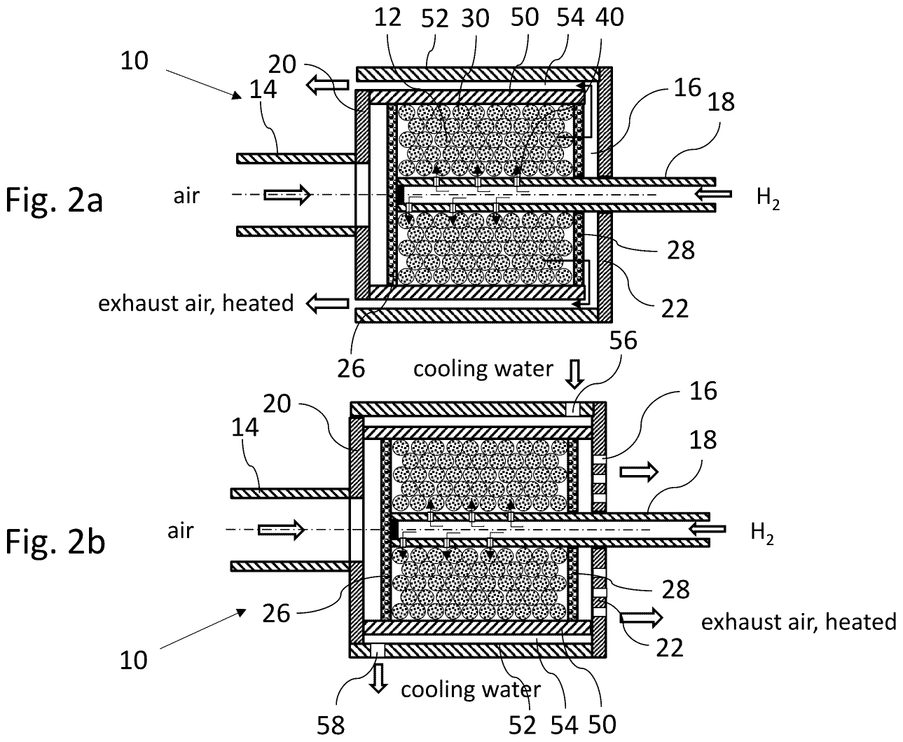

As FIGS. 1 and 2 show, the entire reactor chamber 12 between the flame arresters 20 and 22 can be filled with catalyst pellets 30. Alternatively or additionally, a monolithic catalyst can also be provided.

The flame arresters 26 and 28 have apertures 48 of preferably 0.02 mm to 0.5 mm diameter or equivalent effective pore diameters to provide a correspondingly small extinguishing distance and prevent flame transmission.

A heating element 62 can be arranged in the post-reaction zone 36 of the reactor chamber 12 in order to be able to supply electrical and/or thermal process energy (see FIG. 1b) if required.

The reactor housing can be designed as a heat exchanger. For this purpose, the reactor housing has an inner housing wall 50, which delimits the reactor chamber 12, and an outer housing wall 52, which is spaced from the inner housing wall 50 by an intermediate space 54; see FIGS. 2a and 2b. According to the embodiment shown in FIG. 2a, the exhaust air outlet duct extends at least in sections through the intermediate space. According to the embodiment variant shown in FIG. 2b, the outer housing wall 52 has a coolant inlet 56 and a coolant outlet 58 and the intermediate space 54 is designed as a cooling jacket through which a liquid coolant can flow.

According to a further embodiment of the catalytic recombiner (see FIG. 3), the pre-reaction stage 32 and the main reaction stage 34 as well as the main reaction stage 34 and the post-reaction stage 36 are each separated from one another by a perforated metal plate 38 or 44. In the illustrated embodiment example, the main reaction stage 36 is divided into three main stage regions by two main stage perforated metal plates 40 and 42. Preferably, the perforated metal plates 38, 40, 42 and 44 are connected to the inner housing wall 50 in a thermally conductive manner for the purpose of heat dissipation, as shown in the detailed view in FIG. 3. At least one main stage perforated metal plate 40 has a catalyst coating 60, see also the detailed view in FIG. 3.

The pre-reaction zone 32 may be locally electrically heated and may be partially filled with pellets without catalyst coating. The pre-reaction zone 32 can also be designed only as a mixing zone, i.e. filled exclusively with inert pellets, for example.

The main reaction zone 34 is preferably designed as a heat dissipation zone.

The post-reaction zone 36 can also be electrically heated, see FIG. 1b.

According to one embodiment, the catalytic recombiner is designed as follows:

The catalytic recombiner 100 can be externally insulated or cooled, e.g. if this is necessary for safety reasons to avoid high external temperatures.

The length of the reactor housing 10 is 100 mm and the diameter is 50 mm. The mass is preferably between 0.5 kg and 1 kg. The reactor housing is preferably made of stainless steel.

With a maximum hydrogen flow of 1 L H₂ per 20 s, the catalytic recombiner is designed for a maximum output of around 500 W. With a mass of approx. 1 kg, the heat capacity of the catalytic recombinator 100 is approx. 500 J/K. At an output of 500 W, the catalytic recombinator heats up by about 20 K per 20 s. Preferably, the catalytic recombiner 100 is designed so that a mass flow of approx. 4.5 Nm³/h (standard cubic meters per hour) is achieved at a pressure difference of more than 20 mbar between air inlet duct 14 and exhaust air outlet duct 16. If the gas mixture in the reactor chamber 12 contains approx. 4% hydrogen, this leads to an adiabatic temperature increase of approx. 350 K. The hydrogen is preferably added by lance (see the embodiment examples in FIGS. 1 to 3; i.e. the end of the purge inlet duct 18 is designed as a kind of lance) or directly into the reactor chamber. At both ends of the reactor, a sintered disk is preferably provided as a flame arrester 20 or 22 (see also the embodiment examples in FIGS. 1 to 3). With a heat transfer coefficient of k=100 W/m²K, a surface area of approximately 0.015 m² and a temperature difference across the wall of the reactor chamber of 350 K, approximately 500 W of heat is dissipated. The reactor temperature is then around 200° C. The heating of such a catalytic recombiner with a power of 500 W takes about 100 s until the catalytic recombiner has reached a temperature of more than 100° C. It is therefore advantageous to provide local heating in order to reliably start a catalytic reaction. The heating element 62 shown in FIG. 1B, for example, serves this purpose. Since a catalytic recombiner 100 designed in this way is compact, it can easily withstand the pressure and temperature generated in the event of an explosion. Instead of a purge inlet duct with several dosing outlet openings 46 as shown in FIGS. 1 to 3, the mixing or introduction of the hydrogen by lance can also be carried out by means of a sintering tube projecting into the reactor chamber.

To supply the air via the air inlet duct 14, a diaphragm compressor or another conveying means based on the positive displacement principle (vane pump, piston compressor) is preferably provided, because these can provide a relatively low volume flow at a relatively high pressure loss with the rigid characteristic curve of a positive displacer. In particular, a separate blower or a separate compressor, preferably a diaphragm pump or a vane pump, is therefore provided, which delivers a delivery pressure of 5-300 mbar at 1 to 20 Nm³/h.

If the catalytic recombiner is designed as a continuously operating catalytic combustor, it can easily be operated at higher volume flows and/or 4% to 5% H₂ and/or scaled in diameter and/or length to achieve a capacity of 1 KW to 5 KW due to the more uniform operation and fast response at nominal operating conditions (conversion remains close to 100%). If necessary, several compressors or larger and smaller compressors or compressors of different compressor types can be connected in parallel.

The cooling of the catalytic recombiner is preferably improved by means of design and/or process engineering measures. For example, a downstream heat exchanger for heat transfer to a hot water circuit is advantageous. An enlargement of the outer surface—e.g. by finning—can also serve to transfer heat to the exhaust air flow into a controlled domestic ventilation system (KWL) via a cross-flow heat exchanger or also to transfer heat directly into the room supply air.

As the embodiment examples in FIGS. 2b and 3 show, it is also possible to integrate a liquid heat exchanger into the wall of the reactor chamber. This eliminates the need for a separate heat exchanger if the waste heat from the product gas can be utilized via the controlled domestic ventilation system.

FIG. 4 illustrates how a catalytic recombiner 100 can be operated with purge gas from a fuel cell unit 200 of a home energy center 500. A dynamic, i.e. expandable, purge chamber 300 is provided between the fuel cell unit 200 and the catalytic recombiner 100 to equalize the purge gas flow. In this embodiment, the air inlet duct 14 of the catalytic recombiner 100 is connected to an air reservoir 400, which serves for allowing air to flow from the air reservoir 400 into the reactor chamber 12 of the catalytic recombiner in pulses, the air pulse being synchronized with a purge process—i.e. the supply of hydrogen-containing gas into the reactor chamber 12. For this purpose, in addition to the air reservoir 400, a compressor 410 is also provided in order to fill the air reservoir 400 with air and generate an overpressure in the air reservoir 400. On the output side, the air reservoir 400 is connected to the air inlet duct 14 of the catalytic recombiner 100 via a valve 420. The catalytic recombiner 100 is air-cooled, for example, as shown in FIGS. 2A and 3. The heated exhaust air exiting the exhaust air outlet duct 16 can be supplied to a gas-to-gas heat exchanger 510—preferably an air-to-air heat exchanger—as part of the home energy center 500, in order to heat air that can be supplied to an occupied space.

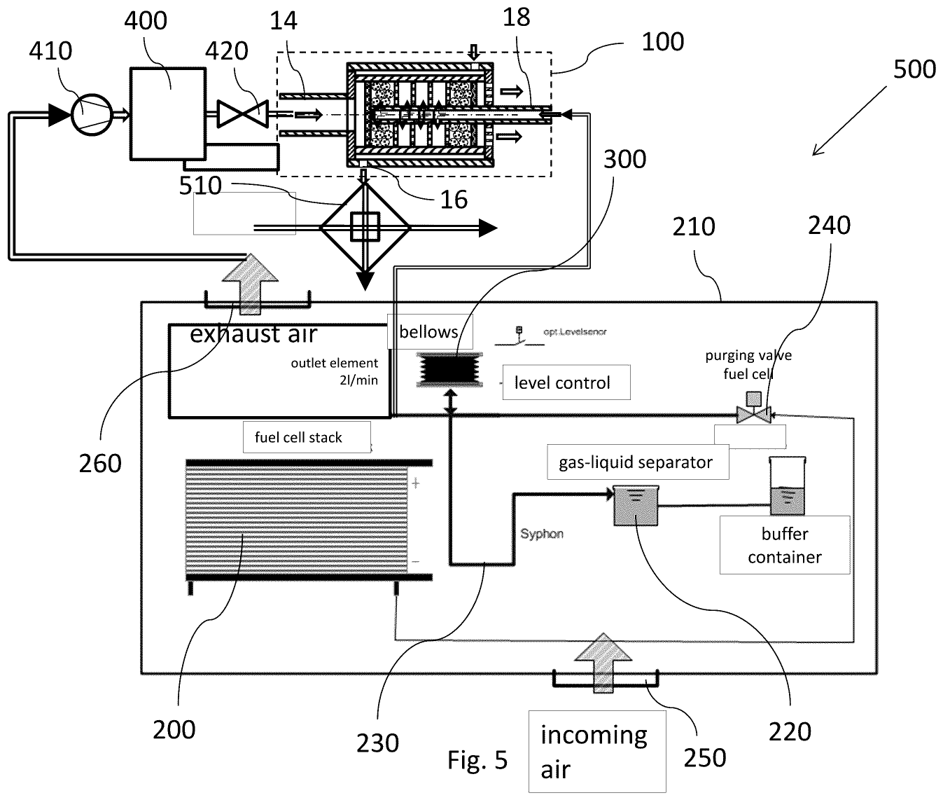

As can be seen in FIG. 5, the fuel cell unit 200 comprises a fuel cell stack and is accommodated in a housing 210 which, in addition to the fuel cell unit 200, also encloses the expandable purge chamber 300. In addition, a gas-liquid separator 220 is located in the housing 210, through which liquid escaping from the fuel cell unit 200, in particular condensed water, is fed to the gas-liquid separator 220. A purge valve 240 is provided to control a pulse-like purge. During intermittent purging of the fuel cell stack, the dynamic purging chamber 300 first expands and then slowly contracts again. In this way, the gas flow is homogenized and fed to the catalytic recombiner 100. The purge gas flow can thus be limited to 2 l/min, for example.

In addition, air flows through the housing 210, in which the fuel cell unit 200, the dynamic purge chamber 300, the gas-liquid separator 220 and the siphon 230 are located, from the outside. A supply air inlet 250 and an exhaust air outlet 260 are provided for this purpose. The exhaust air outlet 260 is fluidically connected to the catalytic recombiner 100 in order to supply it with the air required for recombination. If this air should contain hydrogen, this would also be recombined in the catalytic recombiner 100, i.e. oxidized to water (H₂O). This is shown in FIG. 5.

According to the preferred embodiment shown in FIG. 5, the air, e.g. the exhaust air from the housing 210, is not supplied directly to the catalytic recombiner 100, but via an air reservoir 400, that is a buffer reservoir containing pressurized air.

Not shown is a control system that serves to synchronize the opening of the valve 420 with the triggering of a purging process. This synchronization can also include a time delay of the opening of the valve 420 with respect to the triggering of the purging process, since the hydrogen-containing gas supplied to the reactor chamber of the catalytic recombinator 100 during purging only arrives at the catalytic recombinator 100 with a certain delay. In this way, pulses with hydrogen-containing gas and air pulses can be supplied to the reactor chamber of the catalytic recombinator 100 in a synchronized manner. A pulse with hydrogen-containing gas (i.e. a purge process) takes about half a second. Accordingly, the valve 420 is only opened for approximately one second at a time.

### LIST OF REFERENCE SYMBOLS

10 Reactor housing
12 Reactor room
14 Air inlet duct
16 Exhaust air outlet duct
18 Purge inlet duct
20 Front end wall
22 Rear end wall
24 Perimeter wall
26 Flame arrester
28 Flame trap
30 Pellets (inert pellets or catalyst pellets)
32 Pre-reaction zone, pre-reaction stage
34 Main reaction zone, main reaction stage
36 Post-reaction zone, post-reaction stage
38 Perforated metal plate
40 Perforated metal plate
42 Perforated metal plate
44 Perforated metal plate
46 Dosing outlet openings
50 Inner housing wall
52 Outer housing wall
54 Intermediate space
56 Coolant inlet
58 Coolant outlet
60 Catalytic converter coating
62 Heating element
100 Catalytic Recombiner
200 Fuel cell unit
210 Housing
220 Gas-liquid separator
230 Syphon
240 Purge valve
250 Supply air inlet
260 Exhaust air outlet
300 Dynamic purge chamber
400 Air reservoir
410 Compressor
420 Valve
500 Domestic energy center
510 Gas-gas heat exchanger
AL Exhaust air
H₂ Purge gas
L Air
UZG Lower ignition limit

What is claimed:

1. A catalytic recombiner for the catalytic, flameless recombination of a hydrogen-containing purge gas originating from a fuel cell unit and/or an electrolysis unit of a domestic energy center comprising:
a reactor housing with a reactor chamber, an air inlet duct via which air can flow into the reactor housing, a purge inlet duct, via which a hydrogen-containing purge gas can flow into the reactor housing, and an exhaust air outlet duct via which heated exhaust air can flow out of the reactor housing,
wherein the reactor chamber has at least two reaction stages, namely a pre-reaction stage and/or a main reaction stage and/or a post-reaction stage,
the reactor chamber in the pre-reaction stage is designed in such a way that the air flowing through the reactor chamber has an increased edge mobility during operation,
wherein the reactor chamber in the main reaction stage has a thermal smoothing stage for reducing temporary and local temperature peaks of catalyzed purge gas,
wherein the reactor chamber in the post-reaction stage is adiabatic, and
wherein a gas-permeable flame arrester is provided between the reactor chamber and the air inlet duct and between the reactor chamber and the exhaust air outlet duct.

2. The catalytic recombiner according to claim 1, wherein the gas-permeable flame arresters are designed as sintered disks.

3. The catalytic recombiner according to claim 1, wherein the reactor housing comprises an inner housing wall defining the reactor chamber and an outer housing wall spaced from the inner housing wall by a gap.

4. The catalytic recombiner according to claim 3, wherein the exhaust air outlet duct extends at least in sections through an intermediate space.

5. The catalytic recombiner according to claim 3, wherein the outer housing wall has a coolant inlet and a coolant outlet and an intermediate space is designed as a cooling duct through which a liquid coolant can flow.

6. The catalytic recombiner according to claim 3, wherein the pre-reaction stage and the main reaction stage as well as the main reaction stage and the post-reaction stage are delimited from each other by a perforated metal plate.

7. The catalytic recombiner according to claim 6, wherein the main reaction stage is subdivided by at least one main stage perforated metal plate.

8. The catalytic recombiner according to claim 6, wherein the perforated metal plates are connected to the inner housing wall in a heat-conducting manner for the purpose of heat dissipation.

9. The catalytic recombiner according to claim 7, wherein the at least one main stage perforated metal plate comprises a catalyst coating.

10. The catalytic recombiner according to claim 1, wherein the pre-reaction stage is free of a catalyst during operation and is designed as a mixing stage for mixing hydrogen with air.

11. The catalytic recombiner according to claim 1, wherein flow guiding elements and/or inert pellets are provided in the pre-reaction stage.

12. The catalytic recombiner according to claim 1, wherein the catalytic recombiner is designed as a tube system, in particular a concentric tube system.

13. The catalytic recombiner according to claim 1, wherein the catalytic recombiner is designed for nominal operation with 0% to 10% hydrogen in air.

14. The catalytic recombiner according to claim 1, further comprising an adiabatic stage with an oxidation catalyst.

15. The catalytic recombiner according to claim 1, wherein the increased edge mobility is achieved by a corresponding shape of the reactor chamber and/or by inert mass, for example uncoated pellets of Al₂O₃ or inert metal beads.

16. The catalytic recombiner according to claim 1, wherein a catalytically active layer of the catalytic recombiner has a diffusion barrier layer, which comprises aluminum oxide, at least in a reaction chamber section.

17. A domestic energy center with at least one fuel cell unit and/or one electrolysis unit and with a catalytic recombiner according to claim 1, which is incorporated into the domestic energy center for catalyzing a hydrogen-containing purge gas originating from the fuel cell unit and/or the electrolysis unit.

18. The domestic energy center according to claim 17, wherein the catalytic recombiner is integrated into the domestic energy center in such a way that it can be supplied with electrical and/or thermal process energy from the domestic energy center to activate a catalytic reaction.

19. The domestic energy center according to claim 17, wherein the catalytic recombiner is integrated into the domestic energy center in such a way that heated exhaust air (AL) exiting via the exhaust air outlet duct can be used to heat a room.

20. A method for operating a home energy center according to claim 17, comprising:
passing a hydrogen-containing purge gas originating from a fuel cell unit and/or electrolysis unit into the purge inlet duct of the catalytic recombiner with a pulse-like volume flow of 2 to 20 m³/h per kW nominal power of fuel cell or electrolysis, which is smoothed in time via an equalizing buffer air reservoir and thus reduced by a factor of 5 to 20 conducting an exhaust air volume flow of the home energy center with a volume flow which is greater by at least a factor of 10 than the volume flow of the hydrogen-containing purge gas into the air inlet duct; and
conducting heated exhaust air, which originates from the exhaust air outlet duct of the catalytic recombiner and which is mixed with further exhaust air from the home energy center, into a gas-gas heat exchanger of the home energy center.

21. The method according to claim 20, wherein the exhaust air volume flow of the home energy center is guided into the air inlet duct by means of a compressor.

22. The method according to claim 21, wherein the compressor is activated before a purge of the fuel cell unit and/or electrolysis unit.

23. The method according to claim 21, wherein the compressor continues to run after a final purge of the fuel cell unit and/or electrolysis unit until the exhaust gas temperature has reached a lower limit value, for example 100° C., and is then deactivated.

24. The method according to claim 20, further comprising:
on-demand thermal activation of at least one catalytically active region of the catalytic recombiner with electrical and/or thermal process energy from the home energy center.

25. The method according to claim 20, further comprising:
checking whether the temperature increase of the reactor chamber of the catalytic recombiner rises by a defined amount during the purging process,
heating the reactor chamber to a temperature greater than approximately 100° C. if the temperature increase of the reactor chamber of the catalytic recombiner rises by less than a defined amount during the purging process.

26. A method of operating a home energy center comprising a catalytic recombiner and a fuel cell unit, the fuel cell unit being located in a housing having a supply air inlet and an exhaust air outlet, the exhaust air outlet being fluidically connected to an air reservoir, which in turn is fluidically connected to an air inlet duct of the catalytic recombiner, the catalytic recombiner further comprising a purge inlet duct fluidically connected to the fuel cell unit, the method comprising:
intermittent purging of the fuel cell unit and feeding purge gas exiting the fuel cell unit to the purge inlet duct of the catalytic recombiner
for supplying the purge gas to the catalytic recombiner synchronous, also intermittent supply of air to the air inlet channel of the catalytic recombiner.

27. The method according to claim 26, wherein the air supplied to the air inlet duct of the catalytic recombiner is exhaust air from the housing and is first supplied from the housing to the air reservoir and from there, controlled via a valve, is supplied to the catalytic recombiner in synchronization with the purge gas.

28. The method according to claim 27, wherein the exhaust air originating from the housing is supplied to the air reservoir by means of a compressor configured to generate an overpressure in the air reservoir with respect to the environment.
